(19) United States
(12) Patent Application Publication
(10) Pub. No.: US 2018/0047352 A1
(43) Pub. Date: Feb. 15, 2018

(54) DISPLAY PANEL AND DISPLAY DEVICE BASED ON HSD STRUCTURE

(71) Applicant: Shenzhen China Star Optoelectronics Technology Co. Ltd., Shenzhen, Guangdong (CN)

(72) Inventors: Yang ZHAO, Shenzhen, Guangdong (CN); Meng WANG, Shenzhen, Guangdong (CN)

(73) Assignee: Shenzhen China Star Optoelectronics Technology Co. Ltd., Shenzhen, Guangdong (CN)

(21) Appl. No.: 14/917,019

(22) PCT Filed: Dec. 30, 2015
(86) PCT No.: PCT/CN2015/099717

§ 371 Date: Mar. 6, 2016

(30) Foreign Application Priority Data
Dec. 14, 2015 (CN) 201510928894.5

(51) Int. Cl. G09G 3/36

(52) U.S. Cl. CPC G09G 3/3614; G09G 3/3677; G09G 3/3648; G09G 3/3688; G09G 3/3607; G09G 3/3696

(57) ABSTRACT

The present disclosure discloses a display panel based on a HSD structure, including: a pixel unit array with several couples of pixel units; several couples of scanning lines, each of the couples of scanning lines is disposed between at least one couple of pixel units and connected with the at least one couple of pixel units; a plurality of data lines, the adjacent data lines are disposed between at least one couple of pixel units and connected with the at least one couple of pixel units; a polarity of each of the pixel units is opposite to that of the adjacent pixel units. By the method above, the disclosure can achieve point reversal between pixel units, which improves image quality of a display panel significantly.

### FIELD OF THE DISCLOSURE

The present disclosure relates to a liquid crystal display technology field, and more particularly to a display panel and a display device based on a HSD structure.

### BACKGROUND OF THE DISCLOSURE

A half source driving (HSD) structure is widely applied in manufacturing a display panel, which multiplies the amount of scanning lines and halves the corresponding amount of data lines. Compared with a conventional display panel structure, the amount of signal lines in a display panel with a HSD structure will be reduced significantly, which can decrease the amount of data line driver chips and as well as the costs.

However, a pixel cyclic unit in a display panel with a HSD structure contains 2 or 4 pixels, as shown in FIG. 1, data lines and scanning lines in the HSD structure form a pixel cyclic unit, the pixel cyclic unit contains 2 pixels (A, B). The HSD structure includes at least two columns of pixel units (10, 11), the polarity of the first column of pixel unit 10 and that of the second column of pixel unit 11 is opposite, which fails to achieve point reversal between the first column of pixel unit 10 and the second column of pixel unit 11, reducing image quality of a display panel.

Overall, a display panel and a display device based on a HSD structure are necessary to be provided to overcome the problems above.

### SUMMARY OF THE DISCLOSURE

The technical issue that the present disclosure solves is to provide a display panel and a display device based on a HSD structure, which can better image quality of a display panel.

A proposal of the present disclosure to solve the problems above is: providing a display panel based on a HSD structure, the display panel includes: a pixel unit array with several couples of pixel units; several couples of scanning lines, each of the couples of scanning lines are disposed between at least one couple of pixel units and connected with the at least one couple of pixel units; a plurality of data lines, the adjacent data lines are disposed between at least one couple of pixel units and connected with the at least one couple of pixel units; a polarity of each of the pixel units is opposite to that of the adjacent pixel units; each couple of the scanning lines include a first scanning line and a second scanning line, one of the first scanning line and the second scanning line is connected with one of the each couple of the pixel units, the other one of the first scanning line and the second scanning line is connected with the other one of each couple of pixel units; the data lines include a first data line and a second data line, one of the first data line and the second data line is connected with one of the each couple of the pixel units, the other one of the first data line and the second data line is connected with the other one of each couple of pixel units; polarities of a data voltage transmitted by the first data line and that by the second data line are opposite; each couple of the pixel units include a first pixel unit and a second pixel unit, a polarity of the first pixel unit and that of the second pixel unit are opposite, the first pixel unit and the second pixel unit are disposed adjacently.

The couples of pixel units include at least four couples of the pixel units, the couples of scanning lines include at least two couples of the scanning lines, at least two couples of pixel units are disposed between each of the couples of the scanning lines; the plurality of data lines include at least three data lines, the at least two couples of pixel units are disposed between the adjacent data lines.

To solve the technical problems above, another proposal of the disclosure is: providing a display panel based on a HSD structure, the display panel includes: a pixel unit array with several couples of pixel units; several couples of scanning lines, each of the couples of scanning lines is disposed between at least one couple of pixel units and connected with the at least one couple of pixel unit; a plurality of data lines, the adjacent data lines are disposed between at least one couple of pixel units and connected with the at least one couple of pixel units; a polarity of each of the pixel units is opposite to that of the adjacent pixel units.

Each couple of the scanning lines include a first scanning line and a second scanning line, one of the first scanning line and the second scanning line is connected with one of the each couple of the pixel units, the other one of the first scanning line and the second scanning line is connected with the other one of each couple of pixel units.

The data lines include a first data line and a second data line, one of the first data line and the second data line is connected with one of the each couple of the pixel units, the other one of the first data line and the second data line is connected with the other one of each couple of pixel units.

Polarities of a data voltage transmitted by the first data line and that by the second data line are opposite.

Each couple of the pixel units include a first pixel unit and a second pixel unit, a polarity of the first pixel unit and that of the second pixel unit are opposite, the first pixel unit and the second pixel unit are disposed adjacently.

The couples of pixel units include at least four couples of the pixel units, the couples of scanning lines include at least two couples of the scanning lines, at least two couples of pixel units are disposed between each of the couples of the scanning lines.

The plurality of data lines include at least three data lines, the at least two couples of pixel units are disposed between the adjacent data lines.

The four second pixel units are disposed surrounding the first pixel unit, the four first pixel units are disposed surrounding the second pixel unit.

The display panel is a COA liquid crystal display panel.

To solve the technical problems above, another proposal of the disclosure is: providing a display device, the display panel includes: a pixel unit array with several couples of pixel units; several couples of scanning lines, each of the couples of scanning lines is disposed between at least one couple of pixel units and connected with the at least one couple of pixel unit; a plurality of data lines, the adjacent data lines are disposed between at least one couple of pixel units and connected with the at least one couple of pixel units; a polarity of each of the pixel units is opposite to that of the adjacent pixel units.

Each couple of the scanning lines include a first scanning line and a second scanning line, one of the first scanning line and the second scanning line is connected with one of the each couple of the pixel units, the other one of the first scanning line and the second scanning line is connected with the other one of each couple of pixel units.

The data lines include a first data line and a second data line, one of the first data line and the second data line is connected with one of the each couple of the pixel units, the other one of the first data line and the second data line is connected with the other one of each couple of pixel units.

Polarities of a data voltage transmitted by the first data line and that by the second data line are opposite.

Each couple of the pixel units include a first pixel unit and a second pixel unit, a polarity of the first pixel unit and that of the second pixel unit are opposite, the first pixel unit and the second pixel unit are disposed adjacently.

The couples of pixel units include at least four couples of the pixel units, the couples of scanning lines include at least two couples of the scanning lines, at least two couples of pixel units are disposed between each of the couples of the scanning lines.

The plurality of data lines include at least three data lines, the at least two couples of pixel units are disposed between the adjacent data lines.

The four second pixel units are disposed surrounding the first pixel unit, the four first pixel units are disposed surrounding the second pixel unit.

The display panel is a COA liquid crystal display panel.

Advantages of the disclosure: distinguishing from a conventional technique, the display panel based on a HSD structure of the disclosure includes: a pixel unit array with several couples of pixel units; several couples of scanning lines, each of the couples of scanning lines is disposed between at least one couple of pixel units and connected with the at least one couple of pixel unit; a plurality of data lines, the adjacent data lines are disposed between at least one couple of pixel units and connected with the at least one couple of pixel units; a polarity of each of the pixel units is opposite to that of the adjacent pixel units. By the method above, each pixel unit in a display panel of the disclosure is surrounded by pixel units with opposite polarity, which can achieve point reversal of pixel units and improve image quality of a display panel significantly.

### BRIEF DESCRIPTION OF THE DRAWINGS

FIG. 1 is a structural diagram of a pixel unit array in a display panel with a HSD structure according to a conventional technique;

FIG. 2 is a structural diagram of a display device according to the disclosure;

FIG. 3 is a structural diagram of a pixel unit array in a display panel with a HSD structure according to the disclosure.

FIG. 4 is an amplified structural diagram of a partial region A in FIG. 3.

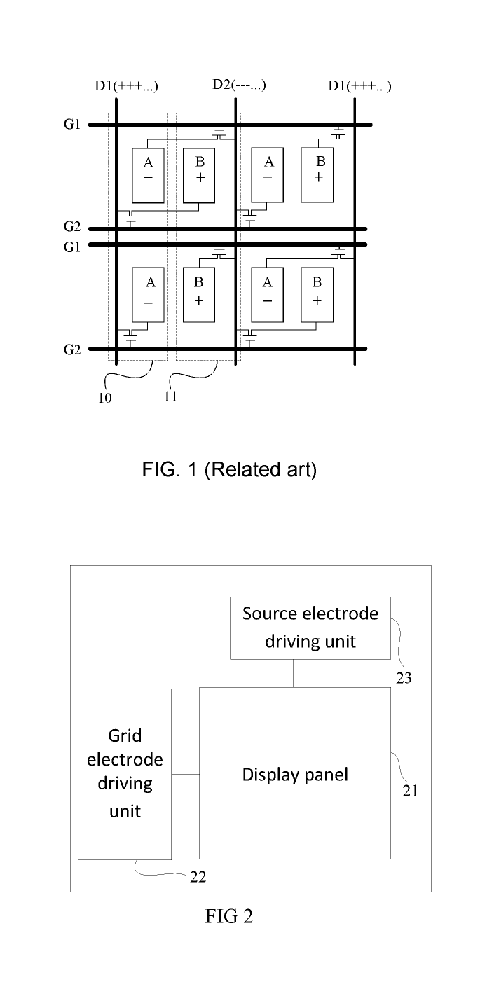

### DETAILED DESCRIPTION OF PREFERRED EMBODIMENTS

Embodiments of the present disclosure are described in detail with the accompanying drawings as follows.

As shown in FIG. 2, FIG. 2 is a structural diagram of a display device according to the disclosure. The display device includes a display panel 21, a grid drive unit 22 and a source drive unit 23. The source drive unit is applied to light corresponding pixels of the display panel 21 according to an image to be displayed, the source drive unit 23 is applied to transfer received display data of the image to be displayed to data voltages, the data voltages are loaded on corresponding pixels of the display panel 21 by data lines to display an image.

In the embodiment, the display panel 21 is a color filter on array (COA) liquid crystal display panel. The technique of a COA substrate included in a COA liquid crystal display panel is a technique integrating color filter substrate on an array substrate. Compared with a conventional technique matching a color filter (CF) and a thin film transistor (TFT), the COA technique provides a proposal that can reduce difficulty in manufacturing a display panel. Specifically, in a conventional technique, a wider black matrix (BM) is applied for insulating light to eliminate errors, but in a COA substrate, the black matrix can be designed to be narrow, the aperture ratio increases correspondingly. Moreover, the COA substrate extends distance between a pixel electrode and a metal wire by a color block layer and reduces the effect of coupling capacitance, the effect of signal delay of the metal wire can be reduce to improve quality of a panel.

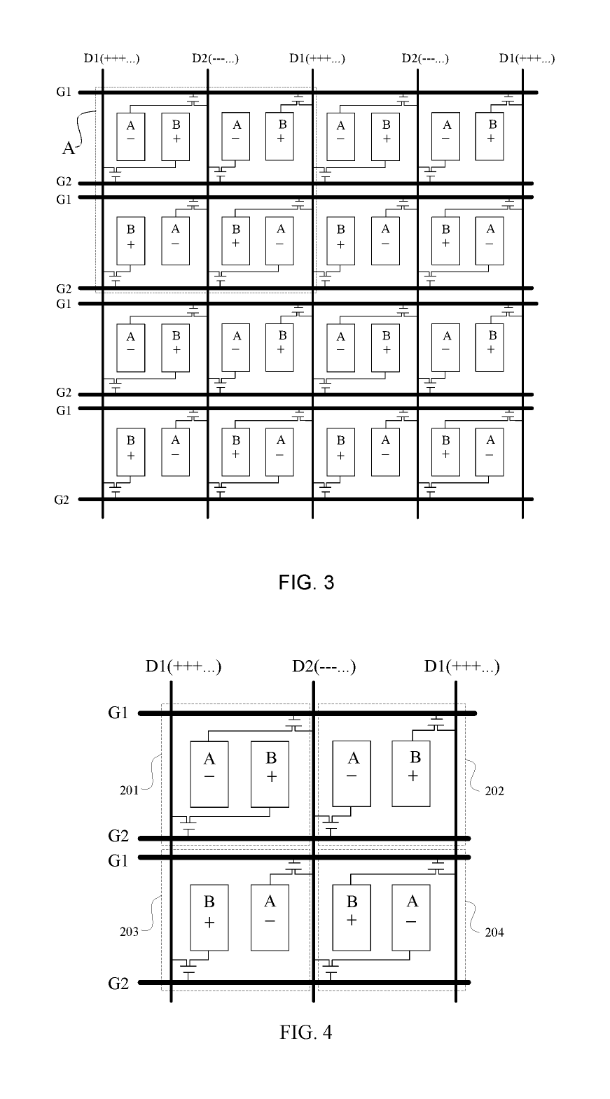

As shown in FIG. 3 and FIG. 4, the display panel 21 includes a pixel unit array, several couples of scanning lines (G1, G2) and several data lines (D1, D2). The pixel unit array includes several couples of pixel units (A, B), scanning lines (G1, G2) and data lines (D1, D2) disposed vertically, a couple of pixel units (A, B) is disposed in a pixel region (e.g. a first pixel region 201 or a second pixel region 202) formed between the scanning lines (G1, G2) and the data lines (D1, D2). Each of the couples of scanning lines (G1, G2) is disposed between at least one couple of pixel units (A, B) and connected with the at least one couple of pixel units (A, B). The adjacent data lines (D1, D2) are disposed between at least one couple of pixel units (A, B) and connected with the at least one couple of pixel units (A, B).

In the embodiment, each couple of the scanning lines (G1, G2) are disposed in sequence, each couple of the scanning lines (G1, G2) include a first scanning line G1 and a second scanning line G2, at least one couple of pixel units (A, B) are disposed between the first scanning line G1 and the second scanning line G2. Each couple of pixel units (A, B) include a first pixel unit A and a second pixel unit B, the first pixel unit A and the second pixel unit Bare disposed adjacently. One of the first scanning line G1 and the second scanning line G2 is connected with one of the each couple of the pixel units (A, B), the other one of the first scanning line G1 and the second scanning line G2 is connected with the other one of each couple of pixel units (A, B).

Specifically, in the first pixel region 201, the first scanning line G1 and the first pixel unit A in the first pixel region 201 are connected, the second scanning line G2 and the second pixel unit B in the first pixel region 201 are connected. And in the second pixel region 202, the first scanning line G1 and the second pixel unit B in the second pixel region 202 are connected, the second scanning line G2 and the first pixel unit A in the second pixel region 202 are connected. In a third pixel region 203, the first scanning line G1 and the first pixel unit A in the third pixel region 203 are connected, the second scanning line G2 and the second pixel unit B in the third pixel region 203 are connected. And in a fourth pixel region 204, the first scanning line G1 and the second pixel unit B in the fourth pixel region 204 are connected, the second scanning line G2 and the first pixel unit A in the fourth pixel region 204 are connected. Each couple of scanning lines of the disclosure provide driving voltages to at least one couple of pixel units, such as in the first pixel region 201, the first scanning line G1 and the second scanning line G2 provide driving voltages to the first pixel unit A and the second pixel unit B in the first pixel region 201; in the second pixel region 202, the other couple of scanning lines such as the first scanning line G1 and the second scanning line G2 provide driving voltages to the first pixel unit A and the second pixel unit B in the second pixel region 202.

In the disclosure, in order to improve the aperture ratio, a ITO (conductive glass) film layer disposed on a base substrate in each pixel unit is stretched, such as stretching marginal area of the ITO film layer, resulting in the whole area of the ITO film layer is larger than the area of the base substrate, by which more space will be on the ITO film layer, increasing aperture ratio of pixel units.

The data lines (D1, D2) include a first data line D1 and a second data line G2. In the embodiment, the first data line D1 and the second data line D2 are disposed in sequence, at least one couple of pixel units (A, B) are disposed between the first data line D1 and the second data line D2. One of the first data line D1 and the second data line D2 is connected with one of the each couple of the pixel units (A, B), the other one of the first data line D1 and the second data line D2 is connected with the other one of each couple of pixel units (A, B).

Specifically, in the first pixel region 201, the first data line D1 and the second pixel unit B in the first pixel region 201 are connected, the second data line D2 and the first pixel unit A in the first pixel region 201 are connected. In the second pixel region 202, the second data line D2 and the first pixel unit A in the second pixel region 202 are connected, the first data line D1 and the second pixel unit B in the second pixel region 202 are connected. In the third pixel region 203, the first data line D1 and the second pixel unit B in the third pixel region 203 are connected, the second data line D2 and the first pixel unit A in the third pixel region 203 are connected. In the fourth pixel region 204, the second data line D2 and the first pixel unit A in the fourth pixel region 204 are connected, the first data line D1 and the second pixel unit B in the fourth pixel region 204 are connected.

Each data line of the disclosure provides data voltages to at least two pixel units respectively, specifically, each data line provides the data voltages to two adjacent pixel regions respectively, such as the second data line D2 provides the data voltage to the first pixel unit A in the first pixel region 201, the second data line D2 provides the data voltage to first pixel unit A in the second pixel region 202 as well.

In the embodiment, polarities of a data voltage transmitted by the first data line D1 and that by the second data line D2 are opposite. If a data voltage transmitted by the first data line D1 is positive, a data voltage transmitted by the second data line D2 is negative. To be clear, the data voltage transmitted by the first data line D1 being positive and the data voltage transmitted by the second data line D2 being negative are not regarded as limitations. In other embodiments, the data voltage transmitted by the first data line D1 can be positive, the data voltage transmitted by the second data line D2 can be negative

Furthermore, the polarity of the first pixel unit A and that of the second pixel unit B are opposite, if the first pixel unit A works as soon as the data voltage received is negative, the second pixel unit B will work as soon as the data voltage received is positive. Similarly, in other embodiments, the first pixel unit A can be designed to work as soon as the data voltage received is positive and the second pixel unit B can be designed to work as soon as the data voltage received is negative according to practical design.

Polarity of each pixel unit is opposite to that of adjacent pixel units, no matter in the same pixel region or adjacent pixel regions, polarities of a pixel unit and adjacent pixel units are opposite, which can reverse polarities between adjacent pixel units, such as polarities of the second pixel unit B in the first pixel region 201 and the first pixel unit A in the second pixel region 202 are opposite; polarities of the second pixel unit B in the first pixel region 201 and the first pixel unit A in the third pixel region 203 are opposite. Preferably, the couples of pixel units (A, B) include at least four couples of the pixel units (A, B), the couples of scanning lines (G1, G2) include at least two couples of the scanning lines (G1, G2), at least two couples of pixel units (A, B) are disposed between each of the couples of the scanning lines (G1, G2). The plurality of data lines (D1, D2) include at least three data lines (D1, D2), the at least two couples of pixel units (A, B) are disposed between the adjacent data lines (D1, D2).

In the disclosure, four second pixel units B are disposed surrounding the first pixel unit A, four first pixel units A are disposed surrounding the second pixel unit B. Polarities of each pixel unit (A, B) and adjacent pixel units (A, B) are opposite, a pixel cyclic unit is formed by eight pixel units (A, B) in the disclosure, such as a pixel cyclic unit is formed by pixel units in the first pixel region 201, the second pixel region 202, the third pixel region 203 and the fourth region 204, compared with a conventional HSD structure, the disclosure improves the amount of pixel units in the pixel cyclic unit, which can reverse polarities between adjacent pixel units and improve image quality of the display panel.

Overall, the display panel based on a HSD structure of the disclosure includes: a pixel unit array with several couples of pixel units; several couples of scanning lines, each of the couples of scanning lines is disposed between at least one couple of pixel units and connected with the at least one couple of pixel unit; a plurality of data lines, the adjacent data lines are disposed between at least one couple of pixel units and connected with the at least one couple of pixel units; a polarity of each of the pixel units is opposite to that of the adjacent pixel units. By the method above, each pixel unit in a display panel of the disclosure is surrounded by pixel units with opposite polarity, which can achieve point reversal between pixel units and improve image quality of a display panel significantly.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A display panel based on a HSD structure, wherein the display panel comprises:
a pixel unit array, comprising several couples of pixel units;
several couples of scanning lines, wherein each of the couples of scanning lines are disposed between at least one couple of pixel units and connected with the at least one couple of pixel unit;
a plurality of data lines, wherein the adjacent data lines are disposed between the at least one couple of pixel units and connected with the at least one couple of pixel units;
wherein a polarity of each of the pixel units is opposite to that of the adjacent pixel units;
each couple of the scanning lines comprising a first scanning line and a second scanning line, one of the first scanning line and the second scanning line connected with one of the each couple of the pixel units, the other one of the first scanning line and the second scanning line connected with the other one of each couple of pixel units;
the data lines comprising a first data line and a second data line, one of the first data line and the second data line connected with one of the each couple of the pixel units, the other one of the first data line and the second data line connected with the other one of each couple of pixel units;
polarities of a data voltage transmitted by the first data line and that by the second data line opposite;
each couple of the pixel units comprising a first pixel unit and a second pixel unit, a polarity of the first pixel unit and that of the second pixel unit opposite, the first pixel unit and the second pixel unit disposed adjacently.

2. The display panel according to claim 1, wherein the couples of pixel units comprise at least four couples of the pixel units, the couples of scanning lines comprise at least two couples of the scanning lines, at least two couples of pixel units are disposed between each of the couples of the scanning lines; the plurality of data lines comprise at least three data lines, the at least two couples of pixel units are disposed between the adjacent data lines.

3. A display panel based on a HSD structure, wherein the display panel comprises:
a pixel unit array, comprising several couples of pixel units;
several couples of scanning lines, wherein each of the couples of scanning lines is disposed between at least one couple of pixel units and connected with the at least one couple of pixel unit;
a plurality of data lines, wherein the adjacent data lines are disposed between at least one couple of pixel units and connected with the at least one couple of pixel units;
wherein a polarity of each of the pixel units is opposite to that of the adjacent pixel units;

4. The display panel according to claim 3, wherein each couple of the scanning lines comprise a first scanning line and a second scanning line, one of the first scanning line and the second scanning line is connected with one of the each couple of the pixel units, the other one of the first scanning line and the second scanning line is connected with the other one of each couple of pixel units.

5. The display panel according to claim 4, wherein the data lines comprise a first data line and a second data line, one of the first data line and the second data line is connected with one of the each couple of the pixel units, the other one of the first data line and the second data line is connected with the other one of each couple of pixel units.

6. The display panel according to claim 5, wherein polarities of a data voltage transmitted by the first data line and that by the second data line are opposite.

7. The display panel according to claim 5, wherein each couple of the pixel units comprise a first pixel unit and a second pixel unit, a polarity of the first pixel unit and that of the second pixel unit are opposite, the first pixel unit and the second pixel unit are disposed adjacently.

8. The display panel according to claim 7, wherein the couples of pixel units comprise at least four couples of the pixel units, the couples of scanning lines comprise at least two couples of the scanning lines, at least two couples of pixel units are disposed between each of the couples of the scanning lines.

9. The display panel according to claim 8, wherein the plurality of data lines comprise at least three data lines, the at least two couples of pixel units are disposed between the adjacent data lines.

10. The display panel according to claim 9, wherein the four second pixel units are disposed surrounding the first pixel unit, the four first pixel units are disposed surrounding the second pixel unit.

11. The display panel according to claim 3, wherein the display panel is a COA liquid crystal display panel.

12. A display device, wherein the display device comprises a display panel, the display panel comprises:
a pixel unit array, comprising several couples of pixel units;
several couples of scanning lines, wherein each of the couples of scanning lines is disposed between at least one couple of pixel units and connected with the at least one couple of pixel unit;
a plurality of data lines, wherein the adjacent data lines are disposed between at least one couple of pixel units and connected with the at least one couple of pixel units;
wherein a polarity of each of the pixel units is opposite to that of the adjacent pixel units.

13. The display device according to claim 12, wherein each couple of the scanning lines comprise a first scanning line and a second scanning line, one of the first scanning line and the second scanning line is connected with one of the each couple of the pixel units, the other one of the first scanning line and the second scanning line is connected with the other one of each couple of pixel units.

14. The display device according to claim 13, wherein the data lines comprise a first data line and a second data line, one of the first data line and the second data line is connected with one of the each couple of the pixel units, the other one of the first data line and the second data line is connected with the other one of each couple of pixel units.

15. The display device according to claim 14, wherein polarities of a data voltage transmitted by the first data line and that by the second data line are opposite.

16. The display device according to claim 14, wherein each couple of the pixel units comprise a first pixel unit and a second pixel unit, a polarity of the first pixel unit and that of the second pixel unit are opposite, the first pixel unit and the second pixel unit are disposed adjacently.

17. The display device according to claim 16, wherein the couples of pixel units comprise at least four couples of the pixel units, the couples of scanning lines comprise at least two couples of the scanning lines, at least two couples of pixel units are disposed between each of the couples of the scanning lines.

18. The display device according to claim 17, wherein the plurality of data lines comprise at least three data lines, the at least two couples of pixel units are disposed between the adjacent data lines.

19. The display device according to claim 18, wherein the four second pixel units are disposed surrounding the first pixel unit, the four first pixel units are disposed surrounding the second pixel unit.

20. The display device according to claim 12, wherein the display panel is a COA liquid crystal display panel.
